(19) United States
(12) Patent Application Publication
(10) Pub. No.: US 2005/0060165 A1
(43) Pub. Date: Mar. 17, 2005

(54) Return-shipping label usage

(75) Inventors: G. Scott Knight, Gresham, OR (US); Adam McLain, Vancouver, WA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 10/661,822

(22) Filed: Sep. 12, 2003

(51) Int. Cl. G06F 17/60

(52) U.S. Cl. 705/1

(57) ABSTRACT

Embodiments of the invention involve a system for monitoring the use of return-shipping labels. The system is generally comprised of a label generation application that creates a return-shipping label having a unique return-shipping label identifier and associates the unique return-shipping label identifier with an authorization identifier that has been provided to a customer desiring to return an item, and a label access application that allows the customer desiring to return an item having the authorization identifier to access and obtain the return-shipping label. The label access application monitors and records information about the return-shipping label including at least the date and time that the customer desiring to return an item accessed the return-shipping label. Other embodiments involve methods of using such a system.

### BACKGROUND OF THE INVENTION

1. Field of the Invention

The various embodiments of the present invention generally relate to returns systems and return-shipping labels. More particularly, the invention relates to systems and methods of return-shipping label distribution useful to facilitate the return of shipped goods from purchasers to senders. The invention also relates to end-use reporting pertaining to access and use of return-shipping labels.

2. Description of Related Art

The increased popularity of the World Wide Web has led to significant growth in catalog and online shopping. The growth in e-commerce reflects in part increasing use of the Internet by experienced online shoppers, greater acceptance and trust of vendors and purchasers of the World Wide Web as a vehicle for sale and purchase of products, and the increasingly broad array of goods available online through growth in the number of merchants offering their products to purchasers over the World Wide Web. These benefits of online shopping, among others, have lead to the growth of online commerce to the extent that many retailers now derive a significant amount of their revenues through online sales.

Some of the benefits to purchasing products online include the ability to avoid shopping hassles such as finding parking spaces, crowds, and the inherent difficulty of walking or driving from store to store to compare products and prices. The World Wide Web enables quick price comparisons across multiple sellers, and access to a wider selection of products. However, there are drawbacks to purchasing goods through a retailer web site. One such drawback is that the current state of online shopping technology does not permit physical or virtual inspection of an item to a degree sufficient to enable the prospective purchaser to determine whether it fits such purchaser's needs. A customer that buys a product offline at a traditional retail store usually has the opportunity to inspect the physical characteristics of an object (e.g., color, size, quality of workmanship, etc.) before making a purchase. In contrast, when a customer shops online their decision to purchase is based largely on a written description of the product and/or a photograph or image of the item, which is often unclear or lacking in detail. No opportunity to inspect the product occurs until after the product is purchased and shipped to the customer. As a result, many products that are purchased online are returned.

The typical return transaction involves a customer contacting a merchant via email or phone, to inform the merchant that the customer intends to return an item previously purchased from the merchant. After approving the return, the merchant obtains a return-shipping label from a commercial carrier, such as, for example UPS®, Inc., FedEx®, Inc., Airborne Express®, Inc., etc. and mails the return-shipping label to the customer, along with any special instructions on how to package the item to be returned. Next, the customer repackages the item, affixes the return-shipping label to the package and drops the package off with the shipper, who delivers it to the merchant.

This return process is both time-consuming and highly manual. It usually takes a week or more for the merchant to obtain a return-shipping label from a carrier and have the label mailed to the customer. In addition, the merchant must have customer service representatives available to receive and approve the customer return request, and to initiate the request to the carrier to have a return-shipping label generated. Further, if the label is lost or destroyed in the mailing process, additional delays and expense can result as the customer contacts the merchant and re-initiates the returns process.

An alternative returns process is sometimes used to avoid some of the delays discussed above. In the alternative returns process, the merchant has a return-shipping label generated for every product sold and encloses the label with the product when it is sent to the customer. The benefit of the alternative return process is that a customer that wishes to return an item no longer needs to contact the merchant and already has the label required to return the good. While this eliminates many of the delays inherent in the traditional returns process, the merchant is at a disadvantage. By including a return-shipping label when the product is sent to the customer, the merchant essentially abrogates the right to refuse a return. And because the merchant is not notified when a customer decides to return an item, the merchant has no idea as to which or how many items are going to be returned, which can lead to inventory management problems. In addition, if the shipping label sent to the customer is missing, lost or destroyed, the delays associated with providing a replacement shipping label return.

Thus, an unsatisfied need exists for an improved method and system for handling product returns that overcomes deficiencies in the prior art, some of which are discussed above.

### BRIEF SUMMARY OF THE INVENTION

Commercial carriers cooperate with merchants to provide return-shipping services for items provided to the merchant's customers. Certain merchants furnish their customers with products that are shipped to customers via commercial carriers or the United States Postal Service (“USPS”). In some instances, and for various reasons, the customer may desire to return the delivered product to the merchant. In today's competitive service-oriented society, the merchant desires to make this return process as simple and convenient as possible for the customer in hopes of retaining the customer's business.

Embodiments of the present invention provide processes for a service provider to obtain information about whether the customer has accessed or obtained a prepaid return-shipping label from the service provider so that the product can be returned to the merchant or another specified location via a commercial carrier. In some instances, the commercial carrier acts as the service provider. This information can assist the merchant in managing their return-item processes and inventory.

Generally, the process involves the customer notifying the merchant that the customer desires to return an item. The merchant verifies that the return meets the merchant's business rules for a return. If so, the merchant either generates a return-shipping label and notifies the service provider of its existence, or has the service provider generate a return-shipping label. The service provider notifies the customer that the return-shipping label is available for the customer's use. The service provider will track a customer's request to access the return-shipping label and can record the date and time that the customer obtained the return-shipping label and furnish this information to the merchant so that the merchant can approximate the arrival date of the returned item. Furthermore, in some instances, the service provider is able to monitor the pick-up of a return item by a commercial carrier when such return item bears a return-shipping label provided by the service provider. This information can be used to notify the merchant of inbound returns, thereby facilitating the merchant's return item processing. The service provider is also able to report on return-shipping labels that are available for customers' use, but have not been accessed.

One embodiment of the invention is a method wherein a service provider receives a request to access a return-shipping label from a customer, records data about such request including the date and time and by whom the request is made, and makes the data available to merchants for their use.

Another embodiment of the invention is a method wherein a merchant is provided information about a customer's access to a return-shipping label. The information is provided by a service provider.

In accordance with another embodiment of the invention, there is provided a system for monitoring the use of return-shipping labels. The system is generally comprised of one or more computers having a label generation application that creates a return-shipping label having a unique return-shipping label identifier and associates the unique return-shipping label identifier with an authorization identifier that has been provided to a customer desiring to return an item, and a label access application that allows the customer desiring to return an item having the authorization identifier to access and obtain the return-shipping label. The label access application monitors and records information about the return-shipping label, including at least the date and time that the customer desiring to return an item accessed the return-shipping label.

In another aspect of the invention, a system provides information about an item being returned to a merchant from a customer. The system comprises a communications device for receiving a return request from a customer and a merchant returns application for determining whether the return request meets the merchant's business rules. A label generation application residing on one or more computers is used for creating an electronic pre-paid return-shipping label if the return request meets the merchant's business rules. The system further includes a notification device for notifying the customer that the electronic pre-paid return-shipping label is available for the customer's access and use; a computer having a printing device that can be used by the customer to access and print the electronic pre-paid return-shipping label; and one or more computers having a commercial carrier package tracking application capable of tracking a package bearing the electronic pre-paid return-shipping label once the package has been received by a commercial carrier and recording such tracking information. Moreover, the system comprises one or more computers having a label access application that recognizes and records the customer's access to the electronic pre-paid return-shipping label and receives and records the tracking information from the commercial carrier package tracking application; and a label reporting application that provides information recorded about the customer's access to the electronic pre-paid return-shipping label and the tracking information from the commercial carrier package tracking application a to a merchant.

Another aspect of the invention includes a method for monitoring the use of a return-shipping label. This method comprises receiving notification that a customer desires to return an item, creating a return-shipping label for the customer's use, making the return-shipping label available for the customer's use, and recording at least a time and date the return-shipping label was made available for the customer's use. The method can further comprise notifying the customer of the return-shipping label's availability, receiving a request for access to the return-shipping label by the customer, and recording at least a date and time of the customer's access to the return-shipping label, if the return-shipping label is accessed by the customer. This method can further include providing the return-shipping label to the customer, recording at least a time and date the customer was provided the return-shipping label, receiving at least a time and date that a package bearing the return-shipping label is received by a commercial carrier, recording at least the time and date that the package bearing the return-shipping label is received by the commercial carrier. The method can also comprise making available to the merchant the recorded information about at least the date and time the return-shipping label was made available to the customer, the date and time of the customer's access to the return-shipping label, at least the date and time the customer obtained the return-shipping label, and at least the time and date the package bearing the return-shipping label is received by the commercial carrier.

One use of the above-described method can be for monitoring the use of a return-shipping label in the shipment of an electronic device. The electronic device can be one or more of a computer, video projector, television, video recorder, stereo device, audio recorder, video display device, radio receiver, radio transmitter, two-way communication device, cellular telephone, digital telephone, analog telephone, personal digital assistant, printer, facsimile device, copier, paging device, camera, and combinations thereof.

Yet another aspect of the invention is a method of providing information about the use of a return-shipping label. The method comprises receiving a return request from a customer to return an item, providing a return material authorization to the customer if the request meets a merchant's business rules for a valid return, otherwise refusing the return request. The method further comprises creating a prepaid return-shipping label for the item, controlling access to the prepaid return-shipping label, notifying the customer that the prepaid return-shipping label has been created and is available for the customer's access and electronically transmitting a uniform resource location or hyper-link to, the customer. The hyper-link may be used by the customer to access the prepaid return-shipping label upon the entry of the proper return material authorization, monitoring the customer's access to the prepaid return-shipping label, receiving information from one or more package tracking applications of one or more commercial carriers to determine if a return item with the return-shipping label has been shipped, and providing information to the customer about the customer's access to the return-shipping label and shipment of the return item.

### BRIEF DESCRIPTION OF THE SEVERAL VIEWS OF THE DRAWING(S)

Having thus described the invention in general terms, reference is now be made to the accompanying drawings, which are not necessarily drawn to scale, and wherein:

FIG. 1 is a diagrammatic representation of an embodiment of the invention;

FIG. 2 is one embodiment of an exemplary system of the invention;

FIG. 3 is an embodiment of an exemplary return-shipping label as may be used in embodiments of the invention;

FIG. 4 is an embodiment of an exemplary web-browser form that may be used to enter information into one or more applications to create a return-shipping label and associate it with the merchant's RMA in embodiments of the invention;

FIG. 5 is an embodiment of an exemplary web-browser form that may be used to enter information regarding the destination address of a return-shipping label into one or more applications in embodiments of the invention;

FIG. 6 is an exemplary embodiment of a web-browser screen that a merchant may access in order to interface with the label-reporting application and generate desired reports;

FIG. 7 is a diagrammatic representation of an embodiment of the invention to provide a pre-paid return-shipping label with the “loaner” item when such “loaner” item is provided to the customer;

FIG. 8 is a flowchart showing methods for monitoring the use of return-shipping labels in an embodiment of the invention;

FIG. 9 is a flowchart showing methods for monitoring the use of return-shipping labels in an embodiment of the invention;

FIG. 10 is a flowchart showing methods for monitoring the use of return-shipping labels in an embodiment of the invention; and

FIG. 11 is a flowchart showing methods for monitoring the use of return-shipping labels in an embodiment of the invention.

### DETAILED DESCRIPTION OF THE INVENTION

The embodiments of the present invention now are described more fully hereinafter with reference to the accompanying drawings, in which some, but not all embodiments of the invention are shown. Indeed, this invention can be embodied in many different forms and should not be construed as limited to the embodiments set forth herein; rather, these embodiments are provided so that this disclosure satisfies applicable legal requirements. Like numbers refer to like elements throughout.

The embodiments of the present invention are described below with reference to block diagrams and flowchart illustrations of methods, apparatuses (i.e., systems) and computer program products. It should be understood that each block of the block diagrams and flowchart illustrations, and combinations of blocks in the block diagrams and flowchart illustrations, respectively, can be implemented by computer program instructions. These computer program instructions can be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions can also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks. Accordingly, blocks of the block diagrams and flowchart illustrations support combinations of means for performing the specified functions, combinations of steps for performing the specified functions and program instruction means for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

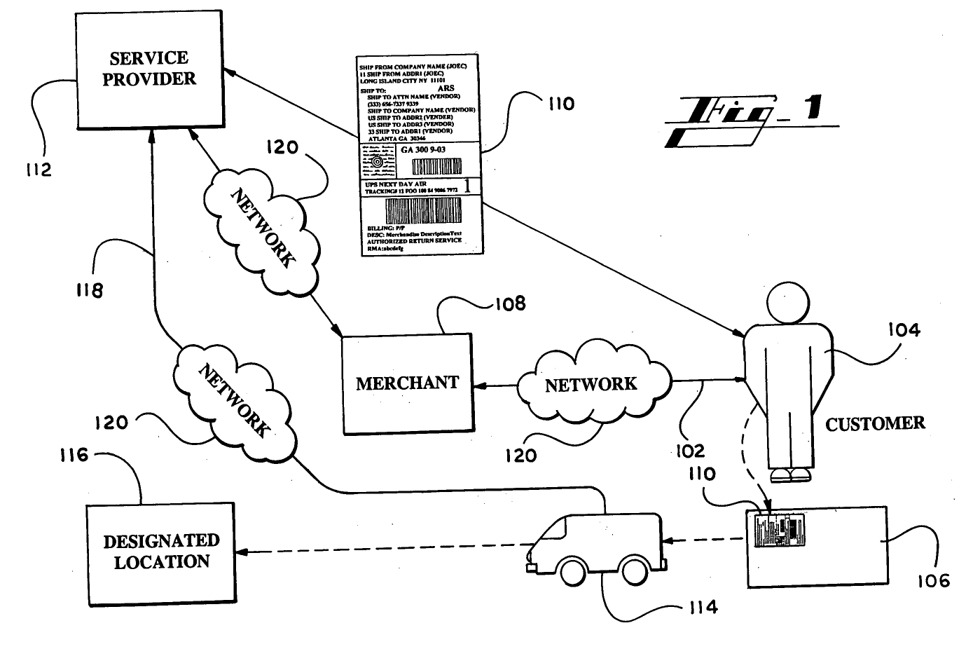

The embodiments of the present invention involve systems and methods whereby a service provider enables merchants to provide the merchants' participating customers with prepaid return-shipping labels for a commercial carrier and is able to report on customers' usage or non-usage of such return-shipping labels. In one embodiment, as shown in FIG. 1, upon receiving notification 102 from a customer 104 that the customer 104 desires to return an item 106, the merchant 108 either prepares or has prepared a return-shipping label 110 for the customer's 104 use. The return-shipping label 110 is made available for the customer 104 to access and the customer 104 is notified of the availability of the return-shipping label 110 by a notification device such as, for example, a telephone, a computer having email receipt capabilities, a facsimile machine, a paging device, etc. A service provider 112 monitors the customer's 104 access to the return-shipping label 110 and is able to report whether the customer 104 has obtained the return-shipping label 110 and, if so, when such access occurred. In other embodiments, a commercial carrier 114 is able to provide information 118 about a received package having the return-shipping label 110 to the service provider 112. The service provider 112 uses the information about the package that contains the return item 106 and bearing the return-shipping label 110 and that has been received by the commercial carrier 114 to determine an expected arrival date of the return item 106 at a location 116 designated by the merchant 108. The commercial carrier 114 transports the return item 106 to the location 116 designated by the merchant 108, as indicated by the return-shipping label 110. Generally, and as shown in FIG. 1, communications between the various entities occurs via one or more networks 120. These networks 120 may be one or more of wired, wireless, optical or any other medium for transmitting or receiving communications and are capable of carrying voice, video, audio, data or other forms of digital and/or analog information.

In the embodiment as shown in FIG. 1, upon receiving notification 102 from a customer 104 that the customer desires to return an item 106, a merchant 108 accesses one or more computer applications that comprise one or more embodiments of the present invention and creates a prepaid return-shipping label 110. These computer applications can reside on one or more servers, computers or processors that are accessible via one or more networks 120 such as, for example, the Internet, or the merchant 108 can have computer applications available on a local system that allows the merchant 108 to create the return-shipping label 110.

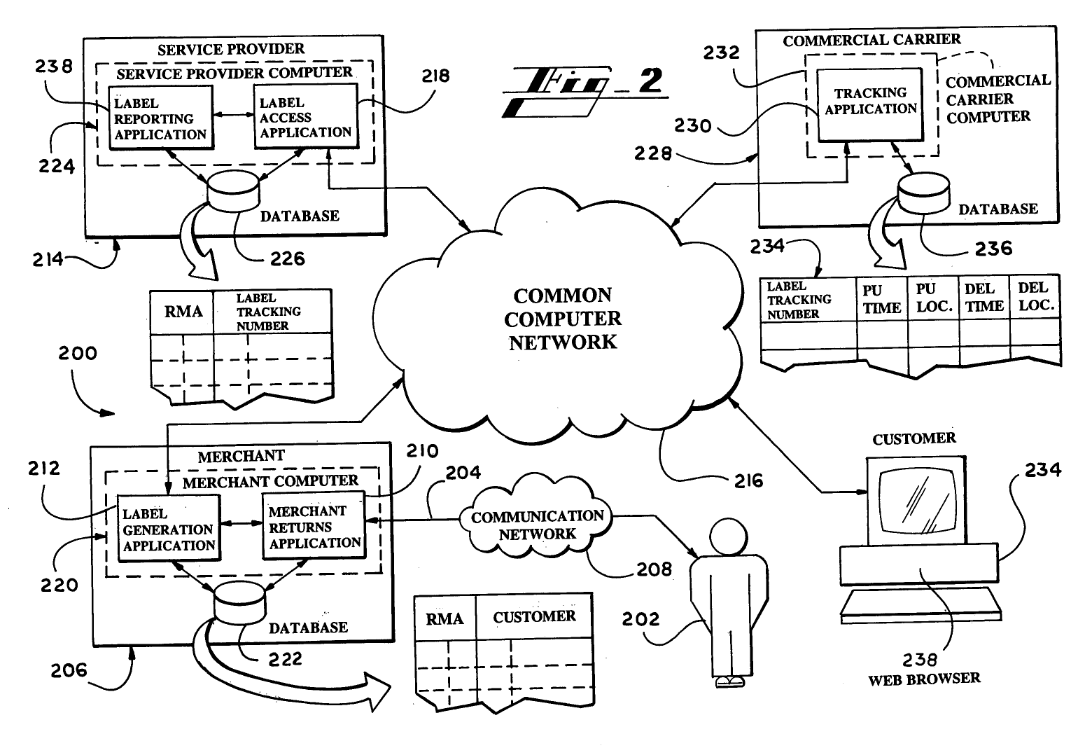

An embodiment of a system of the invention is shown in FIG. 2. This embodiment is comprised of computer hardware, software, applications, operating systems, and servers and is generally accessed by merchants and customers via a wired and/or a wireless network, such as the Internet, for communications purpose and utilizes common Internet protocols such as, for example, HTTP and HTTPS, among others. Common web-browsers such as, for example, Microsoft Internet Explorer™ and Netscape™, among others, may be used to interface with the system of the embodiment of FIG. 2.

In FIG. 2, a customer 202 communicates a return request 204, which indicates the customer's desire to return an item, to a merchant 206. This return request 204 may be made by a communications device and can be transmitted electronically via a network 208 such as a wired, wireless or combination telephone system, the Internet, etc. This return request 204 can be made electronically to the merchant 206 as shown in FIG. 2, or the return request 204 can be made in person or in writing (not shown FIG. 2). Once received by the merchant 206, this return request 204 is considered by the merchant's returns application 210. The merchant's returns application 210 determines whether the return is valid (i.e., whether the return request 204 meets the merchant's business rules for allowing a return). If the return request 204 is valid, then the merchant's returns application 210 will assign a return material authorization (RMA) to the return item. The RMA is communicated to the customer 202 by, for example, telephonic transmission, email, facsimile, other forms of electronic transmission such as paging, verbally, written correspondence, etc. If the return request 204 is not valid, then the merchant 206 will refuse the customer's 202 return request 204 and such refusal is communicated to the customer 202.

The merchant's returns application 210 can be a computer application operating on one or more servers, computers or processors 220, or it can simply be a review of a return request 204 by one or more persons and deciding whether the return request 204 meets, or does not meet, the merchant's business rules concerning returns. As shown in FIG. 1, the merchant's returns application 210 creates a database 222 where the RMA is associated (i.e., linked) with a customer 202.

If the return request 204 is authorized by the merchant's returns application 210, then the merchant 206 creates a return-shipping label 110 with a label generation application 212. The label generation application 212 is a computer application that can be executed by a server, computer or processor 220 under the control of the merchant 206 or a computer 224 under the control of the service provider 214. As depicted in the embodiment of FIG. 2, the label generation application 212 is under the control of the merchant 206. The label generation application 212 electronically creates and stores the return-shipping label 110. In one embodiment, the return-shipping label 110 along with an address, telephone number, email address or other means to contact the customer 202, are electronically transmitted to the service provider 214 such as by, for example, email. In other embodiments, the return-shipping label 110 remains in the memory of a server, computer or processor 220 under the control of the merchant 206, and the service provider 214 is given access to the return-shipping label 110; however, the service provider 214 is also provided with means of contacting the customer 202.

An embodiment of a return-shipping label is shown in FIG. 3. FIG. 3 illustrates a return-shipping label 300 in accordance with an embodiment of the present invention. In this embodiment, a label area 318 includes an origination shipping address 304, a destination shipping address 306, Maxicode™ 308, carrier service level 310, package weight 312, post office code 314, post office bar code 316, package tracking number 302, carrier bar code 320, billing code 322, merchandise description 326, service identification 328, and RMA number 330. Alternative embodiments of the return shipping label 300 are also well-known in the art and are encompassed by the present invention, and may include such additional features as packing instructions, advertisements or a link to a merchant or vendor web site. Additional links may be added to allow a customer to provide feedback or complaints.

The return-shipping label 300 includes a unique identifier (a/k/a a “package-tracking identifier”) such as machine-readable indicia including one-or two-dimensional barcodes 320, RFID tags, etc and may also include human-readable indicia 302, as well as a shipping address 306. The RMA 330 given a customer 202 is shown on the return-shipping label 300 of this embodiment.

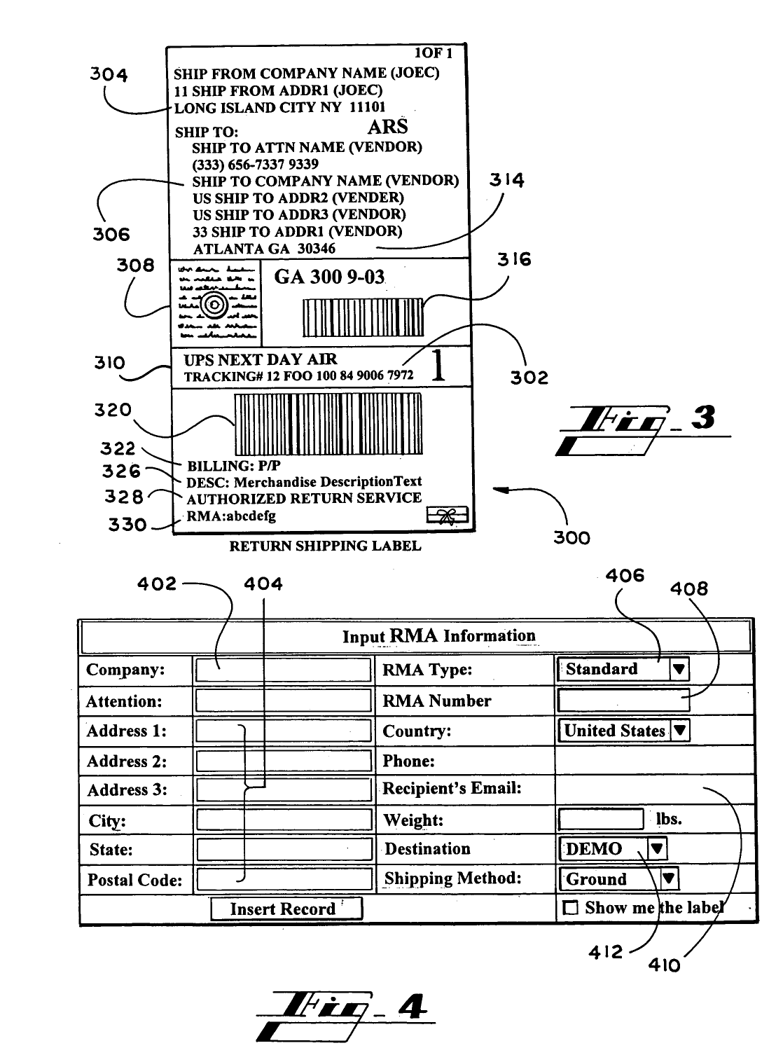

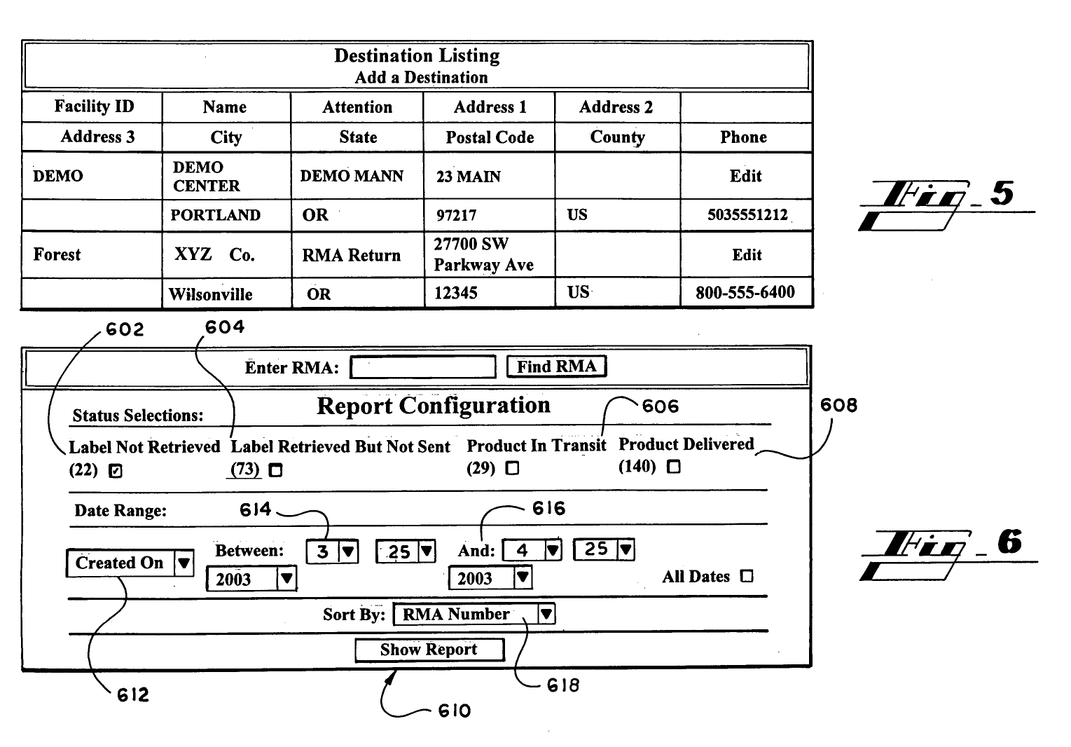

The merchant's RMA 330 is associated with the unique tracking identifier 302 of the return-shipping label 300 in the label generation application 214. The merchant 206, in one exemplary embodiment, is able to create a return-shipping label 300 and associate it with the merchant's RMA 330 by keying information into a form on a web-browser that interfaces with the label generation application 212, such as the web-browser form shown in FIG. 4. This information can include the company 402 authorizing the return, address 404 information about that company 402, as well as RMA type 406, and the RMA number 408. Further information comprises the return-shipping label recipient's email address 410, and the destination 412 of the return item. The destination 412 is chosen from a drop-down menu in this exemplary embodiment. This drop-down menu is established by the merchant 206 entering destination information into a web-browser form such as the form shown in FIG. 5, which also interfaces with the label generation application 212. The label generation application 212 then creates the return-shipping label 300 from the entered information. Information about the label 300 and its associated RMA 330 is then passed to a label access application 218. The label access application creates a database 226 that includes an association between a return-shipping label's 300 RMA 330 and its package tracking number 302.

Referring primarily to FIG. 2, the service provider 214 contacts the requesting customer 202 by using a notification device. Such device can transmit the notification electronically via a network 216 such as a wired, optical, wireless or combination telephone system, the Internet, etc. to the customer. Alternatively, the notification can be made in person or in writing. The customer 202 is notified of the availability of the return-shipping label 300. The customer 202 is provided with a means of accessing the return-shipping label 300 such as, for example, using a browser 238 to access a URL for an Internet website, a telephone number (e.g., a “1-800” number), an account number for dialing in to a private computer network, etc. The date and time that the customer 202 was notified that the return-shipping label 300 was ready to be accessed is recorded by the label access application 218 in its database 226.

In one instance, the customer 202 is sent an email over a network 216 to the customer's designated email address. The email contains a hyper-link to an Internet URL that the customer 202 can use to access a specific web site, enabling the customer 202 to request and subsequently receive the applicable return-shipping label 110. The date and time that this request is made by the customer is recorded by the label access application 218 in its database 226. The customer 202 enters the RMA 330 that was given to the customer 202 by the merchant 206 at the website and the return-shipping label 300 that has a unique tracking identifier 302 that is associated with the entered RMA 330 is transmitted electronically via the network 216 to the customer 202. The customer 202 can then print the return-shipping label 300 locally. In other embodiments, the return-shipping label 300 may be mailed via a postal service from the service provider 214 or the merchant 206 or otherwise placed in the possession or made available to the customer 202. The date and time that the return-shipping label 300 was provided to the customer 202 is recorded by the label access application 218 in its database 226. Similar methods of providing a shipping label to a customer are disclosed in U.S. patent application Ser. No. 10/098,634, “System And Method For Initiating Returns Over A Network,” filed Mar. 13, 2002 by Chalmers et al. and claiming benefit of a provisional application filed on Mar. 14, 2001 (the “Chalmers application”). This application was published on Oct. 17, 2002 and is hereby incorporated by reference herein in its entirety.

In other embodiments, the customer 202 can contact the service provider 214 via a telephone system and request the delivery of a return-shipping label 110. The customer 202 will be asked to enter or speak the RMA 330 in order to have the associated return-shipping label 300 sent to them. The customer 202 can also request and have the return-shipping label 300 sent via an email to the customer's email address. The dates and times of this request and providing of the return-shipping label 300 are recorded by the label access application 218 in its database 226.

If the customer 202 accesses or otherwise is sent the return-shipping label 300, then the label access application 218 detects such access or records a return-shipping label 300 being provided to a customer 202. Generally, the label access application 218 is controlled by the service provider 214.

In one embodiment, as shown in FIG. 2, the label access application 218 receives information from a commercial carrier's 228 package tracking application 230. The package tracking application 230 resides on one or more computers, processors or servers 232 under the control of the commercial carrier 228. The package tracking application 230 tracks packages by their package tracking identifier 302 and stores tracking information 234 including the package tracking identifier 302, pick-up time and date, pick-up location, delivery time and date, and delivery location in its database 236. The information 234 provided to the label access application 218 includes the pick-up date and time that a package bearing the return-shipping label 300 and having a particular package tracking identifier 302 was received by the commercial carrier 228. Because the package tracking identifier 302 has been associated with an RMA 330 by the label generation application 212 and stored in its database 226, and each RMA 330 is associated with a merchant 206, the information 234 can be used to alert the associated merchant 206 that certain items having a return-shipping label 300 and package tracking identifier 302 associated with the merchant's 206 RMA 330 are in-transit to the location 116 designated by the merchant 206. Information 234 from the commercial carrier's 228 package tracking application 230 can also be used to determine when and where the return item 106 was delivered.

The service provider 214 is able to provide the merchant 206 information collected by the service provider 214 indicating whether the customer 202 has, or has not, accessed the system 200 to retrieve the return-shipping label 300. Various reports may be generated by a label-reporting application 238, and such reports provided to the merchant 206 about the customer's 202 use, or non-use, of a provided return-shipping label 300. These reports can be used to provide detailed information regarding the number of returns by customers over a period of time, which can reveal important information to the merchant regarding quality of the products offered by the merchant, potential misunderstandings of the customer as to the nature of the goods and the effectiveness of advertising of the goods, and whether the goods can be sold profitably in the relevant market. In addition, this information can be used for logistics planning by the merchant. By being able to anticipate the number of returns that need to be processed each day, the merchant can staff and equip its return processing operations accordingly, leading to more efficient and cost-effective operation of the merchant's business. In addition, such reports can be of great benefit to the customer, who is permitted to determine by the number of returns over a period of time the quality of products shipped by the merchant, what products did and did not meet the customer's needs, etc.

FIG. 6 is an exemplary embodiment of a web-browser screen that a merchant 206 can access in order to interface with the label-reporting application 238 and generated desired reports. The label-reporting application 238 generates the report(s) from data stored in database(s) 226, which can include one or more records of data including the date and time on which a return-shipping label 300 was made available to a customer 202, the date and time on which a package bearing the return-shipping label 300 was received by the carrier 228, and the date and time on which the product was transported to the merchant 206. Systems and methods for collecting this data are known in the art, and can include the use of computer-generated time-stamps, data generated by hand-held and stationary scanning devices used by carrier's workers and logistics operations to capture data from the shipping label as the carrier transports the associated packages through its logistics network to the merchant.

Reports that can be generated for a merchant 206 include a non-retrieved label report 602, a label retrieved but not sent report 604; a (return) product in transit report 606; and a (return) product delivered report 608. The non-retrieved label report 602 provides information about return-shipping labels 110 that have been made available to a customer 206, but not retrieved. The label retrieved but not sent report 604 provides information about return-shipping labels 300 that have been retrieved by customers 206, but have not been picked up by a commercial carrier 228 to return the item 106. The product in transit report 606 provides information about return-shipping labels 300 that have been retrieved by customers 206 and that have been used to return an item 106, where the item 106 has been picked up by a commercial carrier 228 and is “in transit” to the merchant 206. The product delivered report 608 provides information about where the return-shipping labels 300 have been used by the customer 206 to return an item 106 to the merchant 206 or to a location designated by the merchant 206. The menu 610 allows the user to select the criterion for selecting data to be included in the report, and can be the “created on” date 612, meaning the date the relevant record was created. The date selection fields 614, 616 can be used to set a date range so that the generated report includes only data within the date range. The sort field 618 can be used to sort the data of a report by RMA number, date, etc.

Merchants 206 generally pay a fee to the service provider 214 for each prepaid return-shipping label 110 created by the system 200, in addition to the prepaid shipping charges charged by the carrier 114. Merchants 206 can also be accessed a fee by the service provider 214 for the various reports that are described above.

Other Embodiments

In some situations, often under a warranty condition, a merchant provides a customer with a “loaner” item or product while the customer's product is being repaired or replaced. For example, a computer retailer may have sold a customer a laptop computer that is provided with a one-year warranty. If the customer experiences trouble with the laptop during the warranty period, the merchant can request the customer to ship the computer back to the merchant (or directly to a repair facility) to determine the problem and repair or replace the computer. The merchant, in turn, ships the customer an “interim” or temporary laptop for the customer's use while the customer's laptop is being repaired or replaced. Once the customer's laptop is repaired or replaced, it is shipped back to the customer, and the customer is requested to ship the “loaner” laptop back to the merchant, or to a designation chosen by the merchant.

There are a number of shipping “legs” involved in the exemplary transaction described above that could become quite frustrating, time consuming and expensive for the customer. Utilizing the embodiments of the system described earlier in this patent application, the customer can be provided with a pre-paid return-shipping label for use in sending the defective item or product (e.g., laptop computer) to the merchant or to a repair facility. This would also allow the merchant to know when the customer retrieved the pre-paid return-shipping label and, if integrated with the commercial carrier's package tracking application, when the item to be repaired has been received by the carrier. However, the customer is also responsible for shipping the “loaner” item back to the merchant once the customer's item has been repaired or replaced.

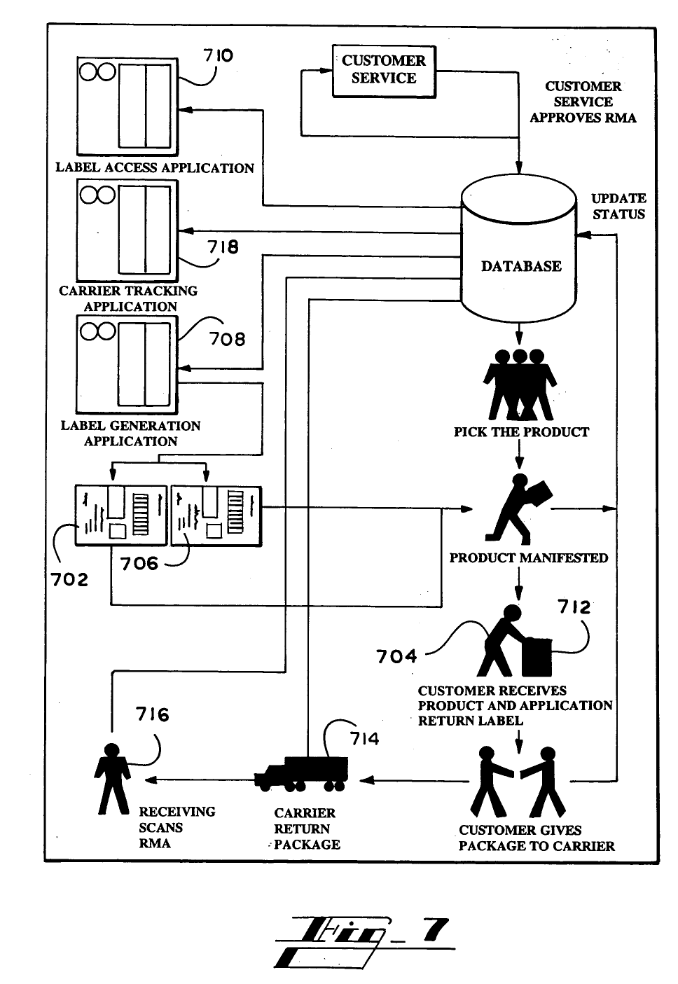

An embodiment of the invention is to provide a pre-paid return-shipping label with the “loaner” item when such “loaner” item is provided to the customer. In this embodiment, as illustrated in FIG. 7, a first shipping label 702 for shipping the “loaner” item to the customer 704 is created and the pre-paid shipping label 706 is created by the label generation application 708 and is either included in the shipment of the “loaner” item to the customer 704 or the customer 704 is provided with information that allows the customer 704 to access the pre-paid return-shipping label 706 (as previously described). The label access application 710 tracks when the return-shipping label 706 is provided or otherwise made available to the customer 704, when obtained by the customer 704, and the package tracking identifier of the return-shipping label 706. Information about when a package 712 bearing the return-shipping label 706 is received by the commercial carrier 714 and when and where 716 such package 712 is delivered by the commercial carrier 714 is tracked by the carrier's tracking application 718 and is provided to the label access application 710.

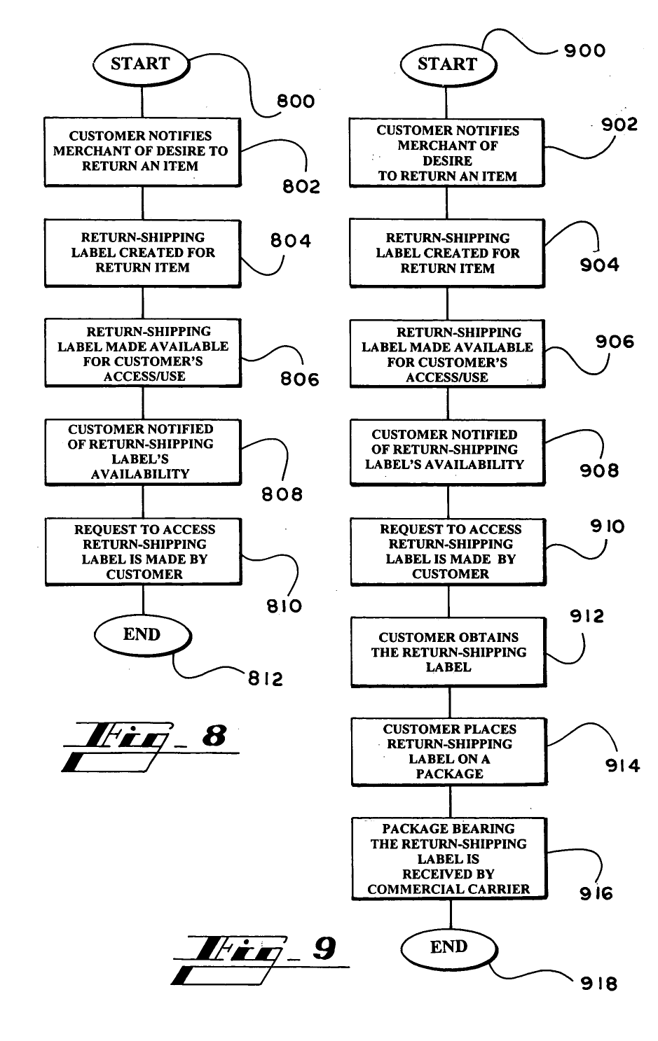

Methods for monitoring the use of return-shipping labels are shown in the flowcharts of FIGS. 8-11. The method of FIG. 8 begins with Step 800. In Step 802, a customer notifies a merchant that the customer desires to return an item. In Step 804, a return-shipping label is created for the customer's use. In Step 806, the created return-shipping label is made available for the customer's use. In Step 808, the customer is notified of the return-shipping label's availability. In Step 810, it is determined whether a network request seeks to access the return-shipping label, and if such request is honored and the return-shipping label is accessed by the customer, at least the date and time of the customer's access along with the nature of the access request is recorded and stored in memory. The method of FIG. 8 ends with Step 812.

The method of FIG. 9 begins with Step 900. In Step 902, a customer notifies a merchant that the customer desires to return an item. In Step 904, a return-shipping label is created for the customer's use. In Step 906, the created return-shipping label is made available for the customer's use. In Step 908, the customer is notified of the return-shipping label's availability. In Step 910, it is determined whether a network request seeks to access the return-shipping label, and if such request is honored and the return-shipping label is accessed by the customer, at least the date and time of the customer's access along with the nature of the access request is recorded and stored in memory. In Step 912, the customer obtains the return-shipping label and at least the time and date of this event is recorded. In Step 914, the customer places the return-shipping label on a package and makes the package available to a commercial carrier. In Step 916, the commercial carrier receives the package bearing the return-shipping label and at least the time and date of such receipt is recorded. The method of FIG. 9 ends with Step 918.

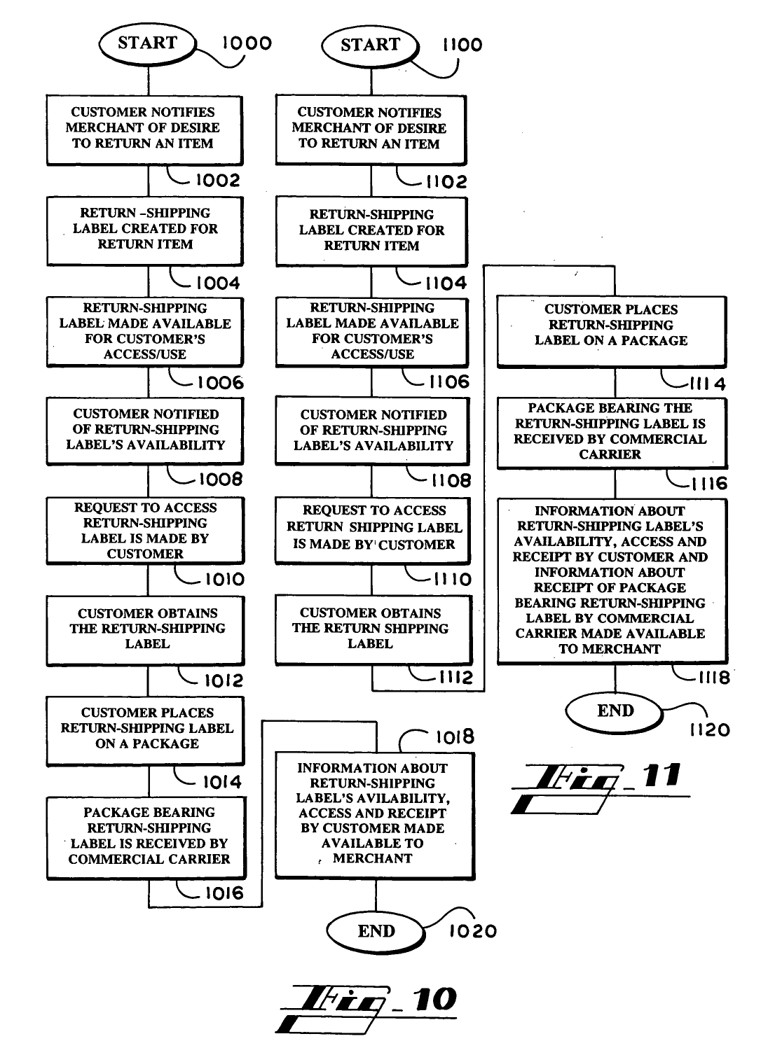

The method of FIG. 10 includes all the steps of the method of FIG. 9, but includes the additional step of making information about the return-shipping labels availability, access and receipt by customers available to the merchant of the customers. In other words, a merchant is provided with the ability to access information about a customer's use of a return-shipping label that has been made available for the customer. The method of FIG. 11 includes all the steps of the method of FIG. 9, but includes the additional step of making information about the return-shipping labels availability, access and receipt by customers available to the merchant of the customers and also includes information about the receipt by a commercial carrier of packages bearing the return-shipping labels and the delivery of such packages by the commercial carrier. In this instance, a merchant will know that packages bearing the return-shipping label associated with the merchant's RMA have been received by a commercial carrier and are in transit to the destination indicated by the merchant.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for monitoring the use of return-shipping labels comprising:
a merchant computer having a label generation application that creates a return-shipping label having a unique return-shipping label identifier and associates the unique return-shipping label identifier with an authorization identifier that has been provided to a customer desiring to return an item; and
a service provider computer having a label access application that allows the customer desiring to return an item having the authorization identifier to access and obtain the return-shipping label, the label access application monitors and records information about the return-shipping label including at least the date and time that the customer desiring to return an item accessed the return-shipping label.

2. The system of claim 1, further comprising:
a commercial carrier computer having a commercial carrier package tracking application that is capable of providing tracking information about a package bearing the return-shipping label having a unique return-shipping label identifier that has been received by a commercial carrier to the label access application.

3. The system of claim 2, wherein the label access application that receives information provided by the commercial carrier package tracking application monitors and records at least the date and time that the package bearing the return-shipping label identifier was received by the commercial carrier.

4. The system of claim 3, wherein the service provider computer further has:
a label reporting application that provides information recorded about a return-shipping label to a merchant.

5. The system of claim 4, wherein the label reporting application that provides information recorded about a return-shipping label to a merchant provides information including at least the date and time that the customer desiring to return an item accessed the return-shipping label and at least the date and time that the package bearing the return-shipping label identifier was received by the commercial carrier.

6. The system of claim 1, wherein the service provider computer further has:
a label reporting application that provides information recorded about a return-shipping label to a merchant.

7. The system of claim 6, wherein the label reporting application that provides information recorded about a return-shipping label to a merchant provides information including at least the date and time that the customer desiring to return an item accessed the return-shipping label.

8. A system for providing information about an item being returned to a merchant from a customer, comprising:
a communications device for receiving a return request from a customer;
a merchant returns application for determining whether the return request meets the merchant's business rules;
a merchant computer having a label generation application for creating an electronic pre-paid return-shipping label if the return request meets the merchant's business rules;
a notification device for notifying the customer that the electronic pre-paid return-shipping label is available for the customer's access and use;
a customer computer having a printing device that can be used by the customer to access and print the electronic pre-paid return-shipping label;
a commercial carrier computer having a package tracking application capable of tracking a package bearing the electronic pre-paid return-shipping label once the package has been received by a commercial carrier and recording such tracking information; and
a service provider computer having a label access application that monitors and records the customer's access to the electronic pre-paid return-shipping label and receives and records the tracking information from the commercial carrier package tracking application; and
a label reporting application that provides information recorded about the customer's access to the electronic pre-paid return-shipping label and the tracking information from the commercial carrier package tracking application a to a merchant.

9. A method for monitoring the use of a return-shipping label, comprising:
receiving notification that a customer desires to return an item;
creating a return-shipping label for the customer's use;
making the return-shipping label available for the customer's use;
recording at least a time and date the return-shipping label was made available for the customer's use;
notifying the customer of the return-shipping label's availability;
receiving a network request to access the return-shipping label, wherein such network request originates with the customer; and
recording at least a date and time of the customer's access to the return shipping label, if accessed by the customer.

10. The method of claim 9, further comprising:
providing the return-shipping label to the customer;
recording at least a time and date the customer was provided the return-shipping label;
receiving at least a time and date that a package bearing the return-shipping label is received by a commercial carrier; and
recording at least the time and date that the package bearing the return-shipping label is received by the commercial carrier.

11. The method of claim 10, further comprising:
making the recorded information about at least the date and time the return-shipping label was made available to the customer, the date and time of the customer's access to the return-shipping label, at least the date and time the customer obtained the return-shipping label, and at least the time and date the package bearing the return-shipping label is received by the commercial carrier available to the merchant.

12. The method of claim 11, wherein the method is used for monitoring the use of a return-shipping label in the shipment of an electronic device.

13. The method of claim 12, wherein the electronic device is one or more chosen from the group consisting of a computer, video projector, television, video recorder, stereo device, audio recorder, video display device, radio receiver, radio transmitter, two-way communication device, cellular telephone, digital telephone, analog telephone, personal digital assistant, printer, facsimile device, copier, paging device, camera, and combinations thereof.

14. The method of claim 11, wherein the recorded information at least the date and time the return-shipping label was made available to the customer, the date and time of the customer's access to the return-shipping label, at least the date and time the customer obtained the return-shipping label, and at least the time and date the package bearing the return-shipping label is received by the commercial carrier available to the merchant so that the merchant can develop a reasonable estimate of the date the return item will arrive at a location designated by the merchant.

15. The method of claim 11, further comprising:
receiving at least a time and date the package bearing the return-shipping label is delivered by the commercial carrier;
recording at least the time and date the package bearing the return-shipping label is delivered by the commercial carrier; and
making the recorded information about at least the time and date the package bearing the return-shipping label is delivered by the commercial carrier available to the merchant.

16. The method of claim 15, wherein the recorded information of
at least the date and time the return-shipping label was made available to the customer,
the date and time of the customer's access to the return-shipping label,
at least the date and time the customer obtained the return-shipping label,
at least the time and date the package bearing the return-shipping label is received by the commercial carrier, and
at least the time and date the package bearing the return-shipping label is delivered by the commercial carrier is made available to the merchant so that the merchant can develop a reasonable estimate of the date the return item arrives at a location designated by the merchant.

17. A method of providing information about the use of a return-shipping label to a merchant, comprising:
receiving a return request from a customer to return an item;
providing a return material authorization to the customer if the request meets a merchant's business rules for a valid return, otherwise refusing the return request;
creating a prepaid return-shipping label for the item;
controlling access to the prepaid return-shipping label;
notifying the customer that the prepaid return-shipping label has been created and is available for the customer's access and electronically transmitting a uniform resource locater hyper-link to the customer, the hyper-link can be used by the customer to access the prepaid return-shipping label upon the entry of the proper return material authorization;
receiving a network request to access to the prepaid return-shipping label;
receiving information from one or more package tracking applications of one or more commercial carriers to about a return item having the return-shipping label, wherein such information includes at least the date and time that the return item having the return-shipping label was received by the commercial carrier; and
providing information to the merchant about the customer's access to the return-shipping label and shipment of the return item.

18. A method comprising:
providing a merchant computer with an application for generating a return-shipping label for use by a customer to return an item purchased from the vendor;
receiving a communication from a customer desiring to return an item purchased from the merchant;
in response to the customer's communication, executing the application with the merchant computer to generate an electronic return-shipping label for transmission to the customer via a network;
executing the application to transmit data necessary for shipping the item to a designated return location from the merchant computer to a service provider computer via a network;
generating a return-shipping label for returning an item at the service provider computer;
transmitting a notification of availability of the return-shipping label for download to a customer via a network, the notification having a network resource identifier to identify a network location for downloading the electronic return-shipping label;
recording at least a date and time that the notification was made to the customer in a database associated with the service provider computer; and
making at least a date and time that the notification was made to the customer available to the merchant computer over the network.

19. A method as claimed in claim 18, wherein the notification is an email notification provided to an email address of the customer, which e-mail address has been provided from the merchant computer to the service provider computer in the data necessary for shipping the item.

20. A method as claimed in claim 18 wherein the data necessary for shipping the item includes a return location address.

21. A method, comprising:
providing a service provider computer capable of receiving a request to access a return-shipping label having a unique package tracking identifier that is linked with a return material authorization issued by a merchant;
receiving the request to access the return shipping label, wherein such request comes from a customer and includes at least the return material authorization;
making at least the date and time the request is received available to the merchant that issued the return material authorization.

22. A method, comprising:
receiving of a communication from a customer to return an item purchased by the customer;
providing a return material authorization to the customer;
creating a return-shipping label that has a unique package tracking identifier that is associated with the return material authorization;
making access to the return-shipping label available to the customer having the return material authorization; and
receiving information about the customer's access to the return-shipping label, wherein such information includes whether the customer has or has not accessed the return shipping label and if the customer has accessed the return shipping label, at least the date and time that such access occurred.
